(19) United States
(12) Patent Application Publication
(10) Pub. No.: US 2026/0301324 A1
(43) Pub. Date: Oct. 1, 2026

(54) DISPLAY CONTROL DEVICE AND PROGRAM

(71) Applicant: FANUC CORPORATION, Minamitsuru-gun, Yamanashi (JP)

(72) Inventor: Daiki HAYASHI, Yamanashi (JP)

(21) Appl. No.: 18/992,720

(22) PCT Filed: Sep. 30, 2022
(86) PCT No.: PCT/JP2022/036704

§ 371 Date: Jan. 9, 2025

(51) Int. Cl. G06T 19/00; G06T 17/00

(52) U.S. Cl. CPC G06T 19/00; G06T 17/00

(57) ABSTRACT

A display control device comprises a setting unit that sets whether a first 3D model has the prescribed relevance with a second 3D model, and a display control unit that puts: the appearance of the first 3D model, which is currently selected, in a first display state; the appearance of the second 3D model, which is not currently selected, in a second display state different from the first display state when the first 3D model is currently selected and the second 3D model is set to have the prescribed relevance to the first 3D model; and the appearances of the first 3D model, which is not currently selected, and the second 3D model, which is not currently selected, in a third display state different from the first and second display states when the second 3D model is not set to have the prescribed relevance to the first 3D model.

### TECHNICAL FIELD

The present disclosure relates to a display control device and a program.

### BACKGROUND ART

Techniques for displaying a three-dimensional (3D) model are known. For example, robot operation simulation software can display a 3D screen on which a robot, components, and the like are three-dimensionally displayed in order to examine, for example, positioning of the robot and the components. 3D models such as computer-aided design (CAD) models of, for example, the robot and the components, which are disposed in a virtual space, can be displayed on the 3D screen. In order to allow a user to recognize a 3D model selected on the screen, the 3D screen has a function for highlighting the 3D model of interest.

### CITATION LIST

### Patent Document

Patent Document 1: Japanese Unexamined Patent Application, Publication No. 2018-039060

### DISCLOSURE OF THE INVENTION

### Problems to be Solved by the Invention

An object to be achieved by an embodiment of the present invention is to provide a display control device and a program that allow a 3D model having a prescribed relationship with a 3D model in a selected state to be more easily identified than in the prior art.

### Means for Solving the Problems

A display control device according to an embodiment includes a setting unit and a display control unit. The setting unit sets whether a first 3D model and a second 3D model have a prescribed relationship with each other. The display control unit is configured to:
put the first 3D model, which is currently selected, visually into a first display state;
put the second 3D model, which is not currently selected, visually into a second display state differing from the first display state, when the first 3D model is currently selected and the second 3D model is set to have the prescribed relationship with the first 3D model; and
put the first 3D model, which is not currently selected, and the second 3D model, which is not currently selected, visually into a third display state differing from the first display state and the second display state, when the second 3D model is not set to have the prescribed relationship with the first 3D model.

### BRIEF DESCRIPTION OF THE DRAWINGS

FIG. 1 is a block diagram illustrating an example of main components of a processing device according to an embodiment;

FIG. 2 is a flowchart illustrating an example of processing performed by a processor in FIG. 1;

FIG. 3 illustrates an example of a 3D screen displayed on a display device in FIG. 1;

FIG. 4 illustrates an example of a 3D screen displayed on the display device in FIG. 1;

FIG. 5 illustrates an example of a 3D screen displayed on the display device in FIG. 1;

FIG. 6 illustrates an example of a 3D screen displayed on the display device in FIG. 1; and

FIG. 7 illustrates an example of a 3D screen displayed on the display device in FIG. 1.

### PREFERRED MODE FOR CARRYING OUT THE INVENTION

A processing device according to an embodiment will be described by referring to the drawings. The scale of parts in the drawings used for the description of the embodiment hereinafter may be changed as appropriate. Components in the drawings used for the description of the embodiment hereinafter may be omitted for the purpose of description.

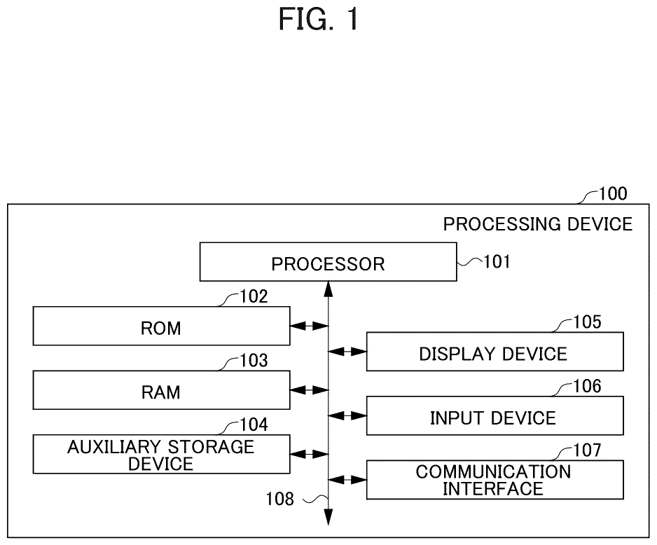

Identical reference marks denote similar elements herein and in the drawings. FIG. 1 is a block diagram illustrating an example of main components of a processing device 100 according to the embodiment.

The processing device 100 performs simulations for the operation of robots. The robot is, for example, an industrial robot provided with a manipulator, a robot arm, or the like. For example, the robot is controlled by a robot controller. However, the robot may include other types. The processing device 100 displays a 3D screen. The 3D screen three-dimensionally displays, for example, the robot, components, and other objects in a virtual space. Here, the components include, for example, peripheral equipment for the robot. For example, the components are controlled by the robot controller.

For example, the processing device 100 is a general-purpose device such as a server device, a PC, a tablet terminal, or a smartphone. Alternatively, the processing device 100 may be, for example, a device dedicated to simulate the operation of robots. As an example, the processing device 100 includes a processor 101, a read-only memory (ROM) 102, a random-access memory (RAM) 103, an auxiliary storage device 104, a display device 105, an input device 106, and a communication interface 107. These components are connected with each other, for example, through a bus 108. The processing device 100 is an example of the display control device.

The processor 101, which is a key section of a computer that performs processing such as computation and control required for operations of the processing device 100, performs, for example, various types of computation and processing. The processor 101 includes, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 may include a combination of multiple ones among these elements. The processor 101 may also include these elements with, for example, a hardware accelerator combined therewith. In order to implement various types of functions of the processing device 100, the processor 101 controls each component on the basis of programs such as firmware, system software, and application software stored in, for example, the ROM 102 or the auxiliary storage device 104. The processor 101 also performs processing to be described hereinafter on the basis of the programs. Some or all of the programs may be incorporated into a circuit of the processor 101.

The ROM 102 and the RAM 103 are main storage devices for the computer that has the processor 101 as a key component. The ROM 102 is a nonvolatile memory used exclusively for data reading. The ROM 102 stores, for example, the firmware among the abovementioned programs. The ROM 102 also stores, for example, data used by the processor 101 when performing various types of processing. The RAM 103 is used for data reading and writing. The RAM 103 is used as, for example, a work area which stores data that is temporarily used by the processor 101 when performing various types of processing. The RAM 103 is typically a volatile memory.

The auxiliary storage device 104 serves as an auxiliary device for the computer that has the processor 101 as a key component. The auxiliary storage device 104 includes, for example, an electric erasable programmable read-only memory (EEPROM), a hard disk drive (HDD), or a flash memory. The auxiliary storage device 104 stores, for example, system software and application software among the abovementioned programs. The auxiliary storage device 104 also stores, for example, data used by the processor 101 when performing various types of processing, data generated through the processing performed by the processor 101, and various types of setting values.

The application software described above includes software for simulating the operation of robots capable of displaying a 3D screen. The auxiliary storage device 104 also stores various types of 3D model data to be displayed on the 3D screen.

The display device 105 displays a screen for informing the operator of the processing device 100 (hereinafter simply referred to as the “operator”), for example, of various types of information. The display device 105 includes, for example, a liquid-crystal display or an organic electro-luminescence (EL) display. The display device 105 may be installed in the processing device 100, or may be externally connected to the processing device 100.

The input device 106 accepts an operation performed by the operator. The input device 106 includes, for example, a keyboard, a keypad, a touch pad, a mouse, or a controller. The input device 106 may be a device for speech input. A touch panel may be used as the display device 105 and the input device 106. In this case, a display panel of the touch panel functions as the display device 105. A pointing device with touch-input of the touch panel functions as the input device 106. The input device 106 may be installed inside the processing device 100, or may be connected externally with the processing device 100.

The communication interface 107 allows the processing device 100 to communicate with other devices, The communication interface 107 performs communication via, for example, a network including a local area network (LAN), the Internet, or the like.

The bus 108, which includes, for example, a control bus, an address bus, and a data bus, carries signals communicated at various parts of the processing device 100.

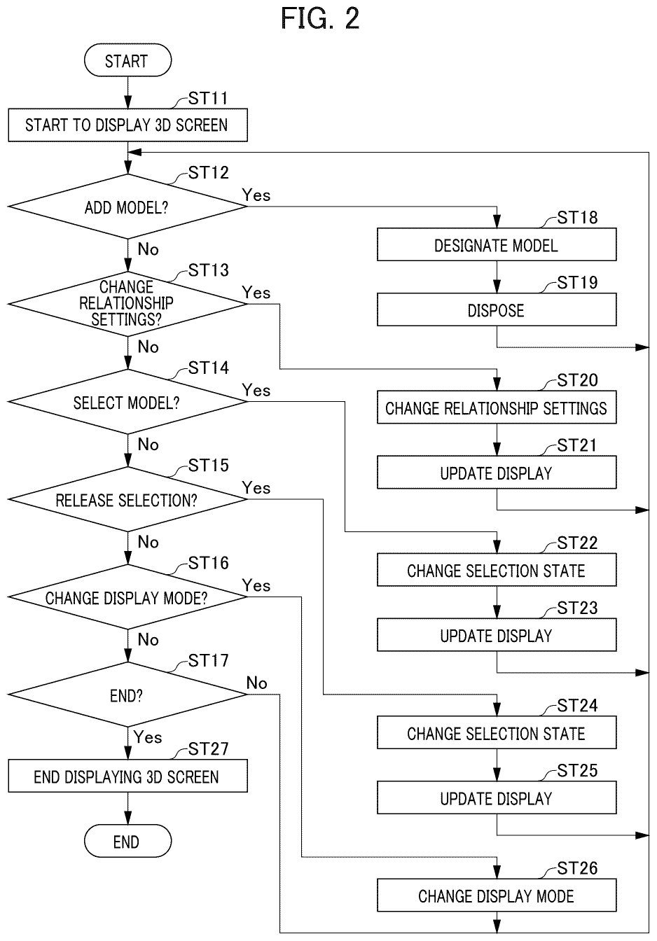

Operations of the processing device 100 according to an embodiment will be described on the basis of, for example, FIG. 2. Details of the processing in the following descriptions of operations are exemplary, and various types of processing with which similar results can be obtained may be used, as appropriate. FIG. 2 is a flowchart illustrating an example of processing performed by the processor 101 of the processing device 100. The processor 101 performs the processing in FIG. 2 on the basis of a program such as software for simulating the operation of robots stored in, for example, the ROM 102 or the auxiliary storage device 104.

For example, the processor 101 starts the processing in FIG. 2 when operation input for giving an instruction to display the 3D screen has been provided to the input device 106 or the like. Alternatively, the processor 101 starts the processing in FIG. 2 when a command or the like for giving an instruction to display the 3D screen has been input from, for example, an external device.

In Step ST11, the processor 101 causes the display device 105 to start to display the 3D screen. Thus, the processor 101 generates an image corresponding to the 3D screen. Then, the processor 101 instructs the display device 105 to display the generated image. Upon receipt of the instruction to display, the display device 105 displays the 3D screen.

For example, a disposed 3D model can be moved and operated and the movement of a viewpoint and various types of functions such as changing a visual field can be executed on the 3D screen. The processor 101 updates displayed contents on the 3D screen as necessary in response to the execution of various types of functions.

In Step ST12, the processor 101 determines whether to add a 3D model into a virtual space. For example, when an operation of adding is performed, the processor 101 determines to add a 3D model. The operation of adding is a preset operation input for allowing the operator to perform the addition of a 3D model. As an example, the operation of adding is an operation performed on an addition button displayed on the display device 105. If the processor 101 does not determine to add a 3D model into the virtual space, the processor 101 gives a determination of No in Step ST12 and then proceeds to Step ST13.

In Step ST13, the processor 101 determines whether to change setting of the relationship for any of 3D models disposed in the virtual space. For example, when an operation of setting change is performed, the processor 101 determines to change setting of the relationship for a 3D model. The operation of setting change is a preset operation input for allowing the operator to instruct the processing device 100 to perform a setting change of the relationship for a 3D model.

As an example, the operation of setting change is an operation performed on a setting change button displayed on the display device 105. Note that descriptions of the relationship and the setting of the relationship will be given hereinafter. If the processor 101 does not determine to change the setting of the relationship for the 3D model, the processor 101 gives a determination of No in Step ST13 and then proceeds to Step ST14.

In Step ST14, the processor 101 determines whether to put any of the 3D models disposed in the virtual space into a selected state. For example, when a selection operation is performed, the processor 101 determines to put a 3D model into a selected state. The selection operation is a preset operation input for allowing the operator to instruct the processing device 100 to put a 3D model into a selected state. A 3D model not in a selected state disposed in the virtual space can be selected through the selection operation, which is performed with, for example, clicking or tapping the 3D model. If the processor 101 does not determine to put a 3D model into a selected state, the processor 101 gives a determination of No in Step ST14 and then proceeds to Step ST15.

In Step ST15, the processor 101 determines whether to release the selected state for any of the 3D models disposed in the virtual space. For example, when a release operation is performed, the processor 101 determines to release the selected state for a 3D model. The release operation is a preset operation input for allowing the operator to instruct the processing device 100 to release the selected state for a 3D model. The selected state of a 3D model disposed in the virtual space can be released through a release operation, which is performed with, for example, clicking or tapping the 3D model. If the processor 101 does not determine to release the selected state for any of the 3D models, the processor 101 gives a determination of No in Step ST15 and then proceeds to Step ST16.

In Step ST16, the processor 101 determines whether to change a display mode. For example, when a mode change operation is performed, the processor 101 determines to change the display mode. The mode change operation is a preset operation input for allowing the operator to instruct the processing device 100 to change the display mode. As an example, the mode change operation is an operation performed on a mode change button displayed on the display device 105. Note that descriptions will be given of the display mode hereinafter. If the processor 101 does not determine to change the display mode, the processor 101 gives a determination of No in Step ST16 and then proceeds to Step ST17.

In Step ST17, the processor 101 determines whether to end displaying of the 3D screen. For example, when an end operation is performed, the processor 101 determines to end displaying of the 3D screen. The end operation is a preset operation input for allowing the operator to instruct the processing device 100 to end displaying of the 3D screen. As an example, the end operation is an operation performed on an end button displayed on the display device 105. If the processor 101 does not determine to end the displaying of the 3D screen, the processor 101 gives a determination of No in Step ST17, and returns to Step ST12. In this way, the processor 101 is in a standby state of repeating Steps ST12 to ST17 until a determination is made to add a 3D model into the virtual space, to change setting of the relationship for a 3D model, to put a 3D model in the selected state, to release the selected state for a 3D model, to change the display mode, or to end displaying of the 3D screen.

When the processor 101 determines to add a 3D model into the virtual space while in the standby state for Steps ST12 to ST17, the processor 101 gives a determination of Yes in Step ST12, and proceeds to Step ST18.

In Step ST18, the processor 101 performs a process of deciding which 3D model to be disposed in the virtual space.

On the basis of, for example, operation input to the input device 106, the processor 101 decides which 3D model to be disposed.

In Step ST19, the processor 101 disposes the 3D model decided in Step ST18 in the virtual space. The processor 101 updates displaying of the 3D screen in accordance with disposed contents.

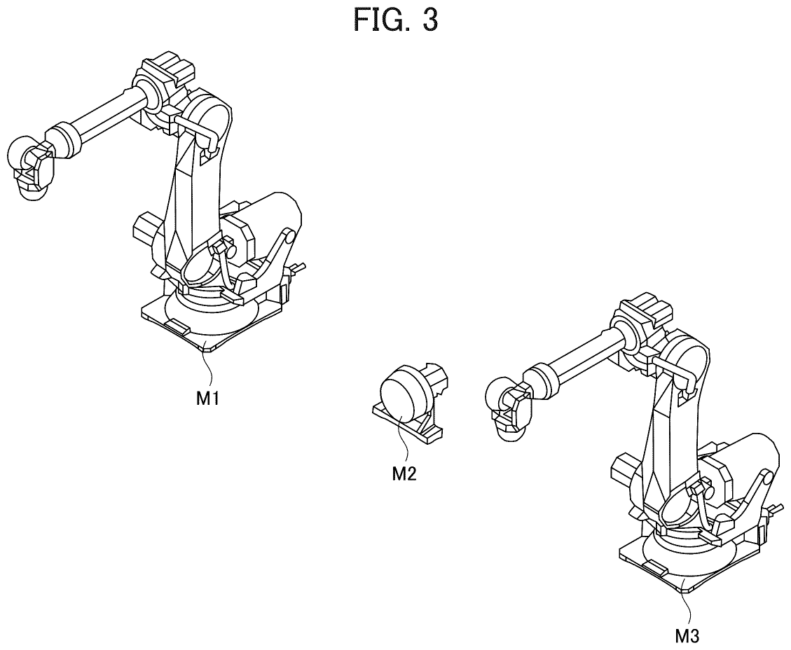

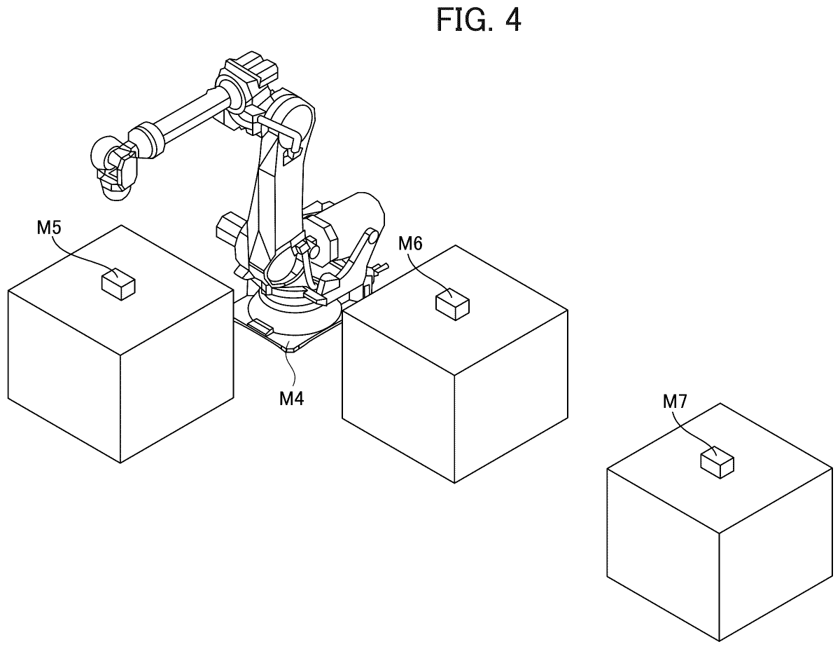

Two examples in FIGS. 3 and 4 are presented as examples of a 3D screen on which some 3D models are disposed. FIGS. 3 and 4 each illustrate an example of a 3D screen displayed on the display device 105. A robot model M1, a component model M2, and a robot model M3 are displayed on the 3D screen depicted in FIG. 3. The robot models M1 and M3 are 3D models of robots. The component model M2 is a 3D model of a component. A robot model M4 and transported object models M5 to M7 are displayed on the 3D screen depicted in FIG. 4. The robot models M1, M3, and M4 are 3D models of robots. The component model M2 is a 3D model of a component. The transported object models M5 to M7 are 3D models of objects to be transported by the robot. FIG. 4 also depicts 3D models of mounts on which the transported object models are placed. After the process of Step ST19, the processor 101 returns to Step ST12. Note that any two of the 3D models disposed in the virtual space are examples of a first 3D model and a second 3D model.

When the processor 101 determines to change setting of the relationship for any of the 3D models disposed in the virtual space while in the standby state for Steps ST12 to ST17, the processor 101 gives a determination of Yes in Step ST13, and proceeds to Step ST20.

In Step ST20, the processor 101 performs processing for setting a relationship. The processor 101 decides on contents on the basis of, for example, operation input to the input device 106.

The following items (i) and (ii) are presented as examples of setting of the relationship.
(i) Which robot is controlled by which robot controller, and which component is controlled by which robot controller.
(ii) Which object is transported by which robot.

Setting of item (i) is described by referring to FIG. 3. It should be assumed that a plurality of robot controllers, including a first robot controller and a second robot controller, can be used to control robots and components. For example, setting can be made such that: the robot model M1 is controlled by the first robot controller; the component model M2 is controlled by the first robot controller; and the robot model M3 is controlled by the second robot controller. When setting is made such that one robot controller controls a plurality of 3D models, a multigroup is formed by the plurality of 3D models which are set to be controlled by the one robot controller. In the above setting example, since the robot model M1 and the component model M2 are controlled by the same first robot controller, a multigroup is formed by the robot model M1 and the component model M2.

Setting of item (ii) is described by referring to FIG. 4. For example, setting can be made such that the transported object models M5 and M6 are objects to be transported by the robot model M4. According to setting of item (ii), an object indicating a transporting start position and an object indicating a transporting end position can be set up. For example, setting can be made such that: the transported object model M5 indicates a start position for an object to be transported by the robot model M4; and the transported object model M6 indicates a start position for the object to be transported by the robot model M4. If setting is made in such a manner, this indicates that the transported object is transported from the position of the transported object model M5 to the position of the transported object model M6 by the robot model M4.

Accordingly, the processor 101, which performs the process of Step ST21, functions as an example of a setting unit that sets whether the first 3D model and the second 3D model have a prescribed relationship with each other.

In Step ST21, the processor 101 updates displayed contents on the 3D screen in accordance with the contents of setting of the relationship in Step ST20. The displayed contents updated here include, for example, the change from a third display manner to a second display manner and the change from the second display manner to the third display manner based on a change in the relationship. Note that descriptions will be given of the third display manner and the second display manner hereinafter. After the process of Step ST21, the processor 101 returns to Step ST12.

When the processor 101 determines to put any of the 3D models disposed in the virtual space into the selected state while in the standby state for Steps ST12 to ST17, the processor 101 gives a determination of Yes in Step ST14, and proceeds to Step ST22.

In Step ST22, the processor 101 puts a 3D model which is designated through, for example, an operation input into the selected state. The processor 101 stores whether each 3D model disposed in the virtual space is in the selected state into the RAM 103, the auxiliary storage device 104, or the like.

In Step ST23, the processor 101 updates the displayed contents on the 3D screen in accordance with the change in the selection state made in Step ST22. At this stage, the processor 101 makes a change from the third display manner to a first display manner for the 3D model to make what the 3D model selected in Step ST22 is currently in the selected state recognizable. The processor 101 also makes a change from the third display manner to the second display manner for one 3D model which has a prescribed relationship with the 3D model which is put into the selected state in Step ST22.

The 3D screen can display 3D models with three types of first to third display manners which are different visually from each other. In the third display manner and the first display manner, the processor 101 varies a 3D model visually by displaying, for example: a difference in color tone of at least a portion of the 3D model, a difference in opacity thereof, a difference in texture thereof, or a difference in rendering thereof, or a change in the presentation of at least a portion of the 3D model, the presence/absence of a prescribed overlaying presentation thereof, or the presence/absence of a prescribed marker. The difference in color tone is, for example, a difference in saturation, lightness, hue, gamma, color balance, or contrast. In the first display manner and the second display manner, the processor 101 varies a 3D model visually by displaying, for example: a difference in color tone of at least a portion of the 3D model, a difference in opacity thereof, a difference in texture thereof, or a difference in rendering thereof; or a change in the presentation of at least a portion of the 3D model, the presence/absence of a prescribed overlaying presentation thereof, or the presence/absence of a prescribed marker such as one that constitutes a sign. In the third display manner and the second display manner, the processor 101 varies a 3D model visually by displaying, for example: a difference in color tone of at least a portion of the 3D model, a difference in opacity thereof, a difference in texture thereof, or a difference in rendering thereof; or a change in the presentation of at least a portion of the 3D model, the presence/absence of a prescribed overlaying presentation thereof, or the presence/absence of a prescribed marker such as one that constitutes a sign.

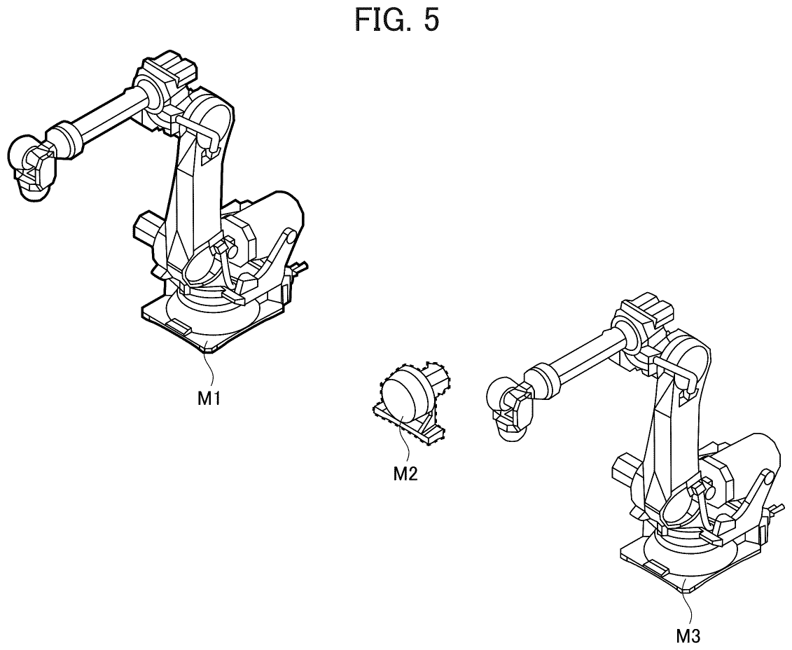

The first display manner to the third display manner will be described by referring to FIGS. 3 and 5. FIG. 5 illustrates an example of a 3D screen displayed by the display device 105. FIG. 5 also indicates a state achieved after the robot model M1 has been changed from the state in FIG. 3 to the selected state.

The 3D models depicted in FIG. 3 are all displayed in the third display manner. The robot model M1 depicted in FIG. 5 is displayed in the first display manner. According to the first display manner indicated in FIG. 5, the outer boundary of the 3D model is surrounded by a solid line. The component model M2 depicted in FIG. 5 is displayed in the second display manner. According to the second display manner indicated in FIG. 5, the outer boundary of the 3D model is surrounded by a broken line. The robot model M3 depicted in FIG. 5 is displayed in the third display manner. Accordingly, the robot model M1, which has been changed into the selected state, is shifted from the third display manner in FIG. 3 to the first display manner in FIG. 5. The component model M2, which has a prescribed relationship with the robot model M1, is shifted from the third display manner in FIG. 3 to the second display manner in FIG. 5. Note that the prescribed relationship in this example is that the two are controlled by the same robot controller.

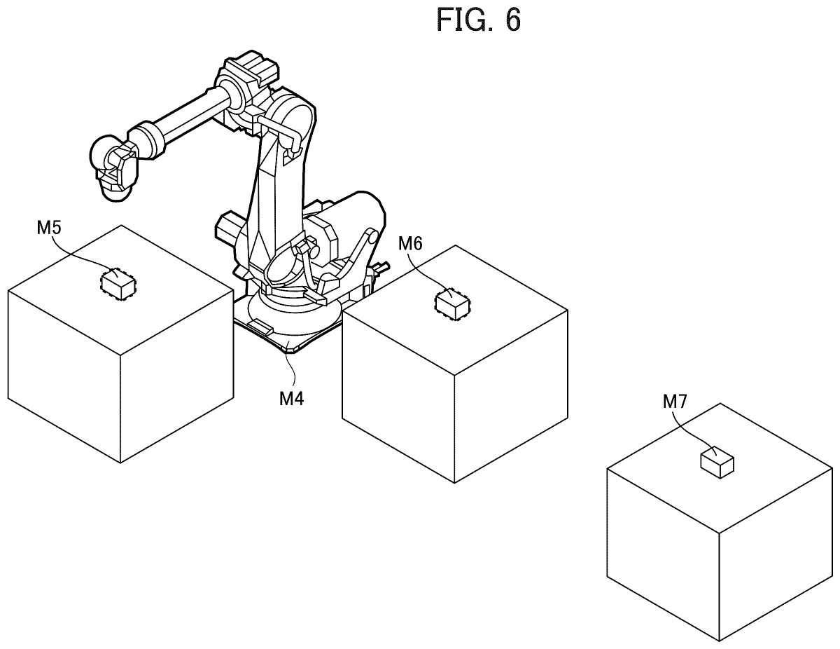

As another example, the third display manner to the second display manner will be described by referring to FIGS. 4 and 6. FIG. 6 illustrates an example of a 3D screen displayed on the display device 105. FIG. 6 also indicates a state achieved after the robot model M4 has been changed from the state in FIG. 3 to the selected state.

The 3D models depicted in FIG. 4 are each displayed in the third display manner. The robot model M4 depicted in FIG. 6 is displayed in the first display manner, The transported object models M5 and M6 depicted in FIG. 6 are each displayed in the second display manner. The transported object model M7 depicted in FIG. 6 is displayed in the third display manner. Accordingly, the robot model M4, which has been changed into the selected state, is shifted from the third display manner in FIG. 4 to the first display manner in FIG. 6. The transported object models M5 and M6, each of which has a prescribed relationship with the robot model M4, are each shifted from the third display manner in FIG. 4 to the second display manner in FIG. 6. The transported object model M7, which does not have the prescribed relationship with the robot model M4, is displayed in the third display manner. Note that the prescribed relationship in this example is that two 3D models correspond to a robot and an object to be transported by the robot. When the transported object model M5 is in the selected state, the robot model M4 is displayed in the second display manner. In this situation, the transported object model M6 may also be displayed in the second display manner. As such, the prescribed relationship in this case is that 3D models are representative of objects to be transported by the same robot.

The 3D screen may also be capable of using different display methods from all of the first to third display manners. The third display manner may include a plurality of display methods that are different visually from each other. The first display manner may include a plurality of display methods that are different visually from each other. The second display manner may include a plurality of display methods that are different visually from each other. For example, display manners may be different from each other in how to distinguish visually from the first and third manners between: one second display manner for a 3D model having a prescribed relationship of being controlled by the same robot controller as another 3D model in the selected state; and another second display manner for a 3D model having a prescribed relationship of being an object to be transported by a robot in the selected state.

It may be possible that a plurality of 3D models are put in the selected state, or only one 3D model is put in the selected state. After the process of Step ST23, the processor 101 returns to Step ST12.

Note that the third display manner is an example of the first display state. The first display manner is an example of the second display state. The second display manner is an example of the third display state.

Accordingly, when a first 3D model is selected and a second 3D model and a third 3D model are not selected, the processor 110, which performs the process of Step ST23, for example, functions as an example of the display control unit that puts: the first 3D model visually into a first display state: the second 3D model, which has a prescribed relationship with the first 3D model, visually into a second display state differing from the first display state; and the third 3D model, which does not have the prescribed relationship with the first 3D model, visually into a third display state differing from the first and second display states. In FIG. 5, the robot model M1 is an example of the first 3D model. The component model M2 is an example of the second 3D model. The robot model M3 is an example of the third 3D model.

When the processor 101 determines to release the selected state for any of the 3D models disposed in the virtual space while in the standby state for Steps ST12 to ST17, the processor 101 gives a determination of Yes in Step ST15, and proceeds to Step ST24.

In Step ST24, the processor 101 changes a 3D model, which is designated through, for example, an operation input, from the selected state to another state. The processor 101 stores whether each 3D model disposed in the virtual space is in the selected state in the RAM 103, the auxiliary storage device 104, or the like.

In Step ST25, the processor 101 updates the displayed contents on the 3D screen in accordance with the change in the selection state that is made in Step ST24. For example, when the robot model M1 on the 3D screen depicted in FIG. 5 is no longer in the selected state, the processor 101 updates the displayed contents on the 3D screen from the state of FIG. 5 to the state of FIG. 3. After the process of Step ST25, the processor 101 returns to Step ST12.

When the processor 101 determines to change the display mode while in the standby state for Steps ST12 to ST17, the processor 101 gives a determination of Yes in Step ST16, and proceeds to Step ST26.

In Step ST26, the processor 101 changes the display mode to one designated through, for example, operation input. The processor 101 updates the displayed contents on the 3D screen in accordance with the change of the display mode. The processor 101 can display the 3D screen in a plurality of types of display modes. The display modes include at least two types of display modes, namely, a first display mode and a second display mode.

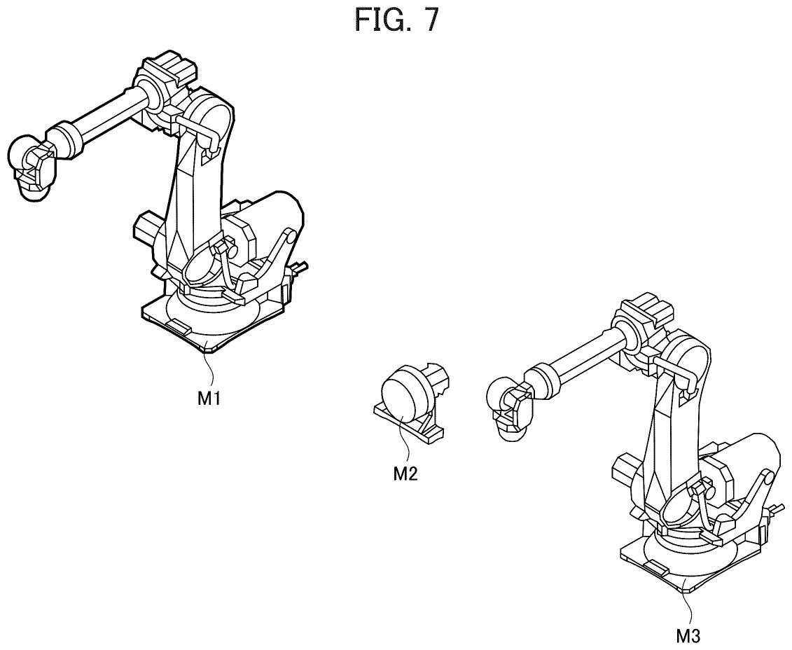

The first and second display modes will be described by referring to FIGS. 5 and 7. FIG. 7 illustrates an example of a 3D screen displayed on the display device 105. FIG. 5 also depicts the 3D screen for the first display mode. FIG. 7 depicts the 3D screen for the second display mode. During the first display mode, as described above, a 3D model in the selected state is displayed in the first display manner, a 3D model having a prescribed relationship with the 3D model in the selected state is displayed in the second display manner, and the other 3D models are displayed in the third display manner. During the second display mode, by contrast, the 3D model in the selected state is displayed in the first display manner, and the other 3D models are displayed in the third display manner. That is, during the second display mode, even the 3D model having a prescribed relationship with the 3D model in the selected state is not displayed in the second display manner, but is displayed in the third display manner.

Thus, although the component model M2 is displayed in the second display manner in FIG. 5, the component model is displayed in the third display manner in FIG. 7. After the process of Step ST26, the processor 101 returns to Step ST12.

Accordingly, the processor 101 functions as an example of the display control unit that controls the display device 105 so as to display a 3D screen in a first display mode, such that: the first 3D model in the selected state is put visually into a first display state; the second 3D model not in the selected state is put visually into a second display state differing from the first display state when the first 3D model is selected and the second 3D model is set to have a prescribed relationship with the first 3D model; and the first 3D model not in the selected state and the second 3D model not in the selected state are put visually into a third display state differing from the first and second display states when the second 3D model is not set to have the prescribed relationship with the first 3D model. The processor 101 also functions as an example of the display control unit that controls the display device 105 so as to display the 3D screen in a second display mode, such that: the first 3D model in the selected state is put visually into the first display state; the second 3D model not in the selected state is put visually into the third display state; and the first 3D model not in the selected state is put visually into the third display state. Furthermore, the processor 101 also functions as an example of the display control unit that controls the display device 105 so as to display a 3D screen in the second display mode, such that the first 3D model is put visually into the first display state, and the second and third 3D models are put visually into the third display state when the first 3D model is selected and the second 3D model and the third 3D model are not selected.

When the processor 101 determines to end displaying of the 3D screen while in the standby state for Steps ST12 to ST17, the processor 101 gives a determination of Yes in Step ST17, and proceeds to Step ST27.

In Step ST27, the processor 101 controls the display device 105 so as to end displaying of the 3D screen. After the process of Step ST27, the processor 101 ends processing indicated in FIG. 2.

The processing device 100 according to the embodiment displays a 3D model in the selected state and a 3D model not in the elected state such that the two 3D models are different visually from each other. The processing device 100 according to the embodiment also causes one 3D model having a prescribed relationship with another 3D model in the selected state to be displayed different visually from the other 3D model. Furthermore, the processing device 100 according to the embodiment causes one 3D model not in the selected state that does not have a prescribed relationship with another 3D model in the selected state to be displayed different visually from the other 3D model and a 3D model having the prescribed relationship with the other 3D model. In this way, operators and the like can understand which 3D model has a prescribed relationship with a 3D model in a selected state simply by seeing a display provided by the processing device 100 according to the embodiment. Therefore, the processing device 100 according to the embodiment allows one 3D model having a prescribed relationship with another 3D model in the selected state to be better identified compared with the prior art.

The processing device 100 according to the embodiment can use two types of display modes, namely, the first and second display modes. During the second display mode, a first 3D model having a prescribed relationship with a second 3D model in the selected state is displayed in the same manner as a third 3D model that does not have the prescribed relationship with the second 3D model. Thus, operators and the like can set the second display mode when, for example, it is unnecessary to identify which 3D model has a prescribed relationship with a 3D model in the selected state.

As the prescribed relationship, the processing device 100 according to the embodiment uses a relationship of being controlled by the same controller as a 3D model in the selected state. Accordingly, the processing device 100 according to the embodiment allows one 3D model controlled by the same controller as another 3D model in the selected state to be easily identified.

As the prescribed relationship, the processing device 100 according to the embodiment uses a relationship of being one 3D model and another 3D model to be transported by the one 3D model. Accordingly, the processing device 100 according to the embodiment allows one 3D model indicating an object that is to be transported by another 3D model in the selected state to be easily identified.

The embodiment described above may alternatively be carried out in variations as shown below. As an example, consideration should be given to two 3D models, namely, a model Ma and a model Mb having a prescribed relationship with each other. According to the embodiment described above, the model Ma is displayed in the first display manner and the model Mb is displayed in the second display manner, when the model Ma is in the selected state and the model Mb is not in the selected state. When the selection states of the models Ma and Mb are switched, i.e., when the model Ma is not in the selected state and the model Mb is in the selected state, the model Ma is displayed in the second display manner, and the model Mb is displayed in the first display manner. According to the embodiment described above, as noted above, the models Ma and Mb are symmetric with each other in terms of selection state and display state. However, the models Ma and Mb may not necessarily need to be symmetric with each other in terms of selection state and display state. When the models Ma and Mb are not symmetric with each other, the model Ma is displayed in the first display manner and the model Mb is displayed in the second display manner when the model Ma is in the selected state and the model Mb is not in the selected state. When the selection states of the models Ma and Mb are switched, i.e., when the model Ma is not in the selected state and the model Mb is in the selected state, the model Ma is displayed in the third display manner, and the model Mb is displayed in the first display manner. Alternatively, when the model Ma is in the selected state and the model Mb is not in the selected state, the model Ma is displayed in the first display manner, and the model Mb is displayed in the third display manner. When the selection states of the models Ma and Mb are switched, i.e., when the model Ma is not in the selected state and the model Mb is in the selected state, the model Ma is displayed in the second display manner, and the model Mb is displayed in the first display manner.

In the embodiment described above, the software for simulating robot operation displays a 3D screen. However, other types of software may alternatively display a 3D screen. The other types of software include, for example, various types of 3D CG software such as 3D CAD software, 3D CG creation software, and 3D image creation software.

In the embodiment described above, robots, components, and transported objects have been described as 3D models disposed in a virtual space. However, 3D models disposed in the virtual space are not limited to these, and may include 3D models of various objects such as persons, animals, machines, or still objects.

The above embodiment has been described by taking a robot controller as an example of the controller for controlling 3D models. However, the controller for controlling 3D models may be a controller other than the robot controller.

The processor 101 may be implemented instead with the hardware configuration of circuits partly or entirely for the processing which is implemented by the program as described above in the embodiment.

The program for implementing the processing in the embodiment is handed over in a state of being stored in a non-transitory storage medium inside a device for example.

However, this device may be handed over without the program being stored therein. The program may be handed over separately and written into the device. For example, the handover of the program in this situation can be achieved by recording the same in a removable non-transitory recording medium or by downloading the same via a network such as the Internet or a LAN.

The embodiment of the present invention has been described as examples and may not limit the scope of the present invention. The embodiment of the present invention can be implemented in various aspects without departing from the gist of the present invention.

### EXPLANATION OF REFERENCE NUMERALS

100: Processing device
101: Processor
102: ROM
103: RAM
104: Auxiliary storage device
105: Display device
106: Input device
107: Communication interface
108: Bus
M1, M3, M4: Robot model
M2: Component model
M5, M6, M7: Transported object model

1. A display control device comprising:
a setting unit that sets whether a first 3D model and a second 3D model have a prescribed relationship with each other; and
a display control unit configured to:
put the first 3D model, which is currently selected, visually into a first display state;
put the second 3D model, which is not currently selected, visually into a second display state differing from the first display state, when the first 3D model is currently selected and the second 3D model is set to have the prescribed relationship with the first 3D model; and
put the first 3D model, which is not currently selected, and the second 3D model, which is not currently selected, visually into a third display state differing from the first display state and the second display state, when the second 3D model is not set to have the prescribed relationship with the first 3D model.

2. A display control device comprising:
a display control unit configured to:
put a first 3D model visually into a first display state;
put a second 3D model, which has a prescribed relationship with the first 3D model, visually into a second display state differing from the first display state; and
put a third 3D model, which does not have the prescribed relationship with the first 3D model, visually into a third display state differing from the first display state and the second display state, when the first 3D model is currently selected and the second 3D model and the third 3D model are not currently selected.

3. The display control device according to claim 1, wherein:
the display control unit is capable of setting one of at least two types of display modes including a first display mode and a second display mode;
the display control unit puts the first 3D model, which is currently selected, visually into the first display state, during the first display mode;
the display control unit puts the second 3D model, which is not currently selected, visually into the second display state, when the first 3D model is currently selected and the second 3D model is set to have the prescribed relationship with the first 3D model;
the display control unit puts the second 3D model, which is not currently selected, visually into the third display state, when the second 3D model is not set to have the prescribed relationship with the first 3D model;
the display control unit puts the second 3D model, which is not currently selected, visually into the third display state, and the first 3D model, which is not currently selected, visually into the third display state, when the first 3D model is not currently selected; and
the display control unit puts the first 3D model, which is currently selected, visually into the first display state, the second 3D model, which is not currently selected, visually into the third display state, and the first 3D model, which is not currently selected, visually into the third display state, during the second display mode.

4. The display control device according to claim 2, wherein:
the display control unit is capable of setting one of at least two types of display modes including a first display mode and a second display mode;
the display control unit puts the first 3D model visually into the first display state, the second 3D model visually into the second display state, and the third 3D model visually into the third display state during the first display mode, when the first 3D model is currently selected and the second 3D model and the third 3D model are not currently selected; and
the display control unit puts the first 3D model visually into the first display state, and the second 3D model and the third 3D model visually into the third display state during the second display mode, when the first 3D model is currently selected and the second 3D model and the third 3D model are not currently selected.

5. The display control device according to claim 1, wherein
the prescribed relationship between the first 3D model and the second 3D model is that the first 3D model and the second 3D model are controlled by a same controller.

6. The display control device according to claim 1, wherein
the prescribed relationship between the first 3D model and the second 3D model is that the second 3D model is a 3D model that indicates an object to be transported by the first 3D model.

7. A non-transitory computer readable storage medium storing a program for causing a processor of a display control device to function as:
a setting unit that sets whether a first 3D model and a second 3D model have a prescribed relationship with each other; and
a display control unit configured to:
put the first 3D model, which is currently selected, visually into a first display state;
put the second 3D model, which is not currently selected, visually into a second display state differing from the first display state, when the first 3D model is currently selected and the second 3D model is set to have the prescribed relationship with the first 3D model;
put the second 3D model, which is not currently selected, visually into a third display state differing from the first display state and the second display state, when the second 3D model is not set to have the prescribed relationship with the first 3D model; and
put the second 3D model, which is not currently selected, visually into the third display state, and the first 3D model, which is not currently selected, visually into the third display state, when the first 3D model is not currently selected.

8. A non-transitory computer readable storage medium storing a program for causing a processor of a display control device to function as:
a display control unit configured to: put a first 3D model visually into a first display state, when the first 3D model is currently selected and a second 3D model and a third 3D model are not currently selected,
put the second 3D model, which has a prescribed relationship with the first 3D model, visually into a second display state differing from the first display state; and
put the third 3D model, which does not have the prescribed relationship with the first 3D model, visually into a third display state differing from the first display state and the second display state.
